(19) United States
(12) Patent Application Publication
(10) Pub. No.: US 2009/0049974 A1
(43) Pub. Date: Feb. 26, 2009

(54) Combination of saw machine and granite working plate

(76) Inventor: Lee-Cheng Chang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/058,822

(22) Filed: Mar. 31, 2008

(30) Foreign Application Priority Data
Aug. 21, 2007 (TW) 96130821

(51) Int. Cl. B26D 1/157

(52) U.S. Cl. 83/698.51

(57) ABSTRACT

A saw machine includes a housing, with the housing including a support collar disposed on the top edge thereof and two fixed portions respectively disposed in the interior thereof below the support collar, at least one of attached portions defined between the support collar and the fixed portions. Two locking devices are respectively set in the attached portions and fixed to an associated fixed portions, with each locking device disposed below and not exposed from the support collar. A saw means is provided in the housing and installed to the locking devices. A granite working plate is installed onto the top of the support collar and spaced from each locking device.

### BACKGROUND OF THE INVENTION

1. Field of the Invention

The present invention relates to a saw machine.

2. Description of the Related Art

Referring to FIG. 1, a conventional saw machine includes a housing 91, a support device 911 installed onto the top of the housing 91, a locking device 92 disposed on the support device 911 and exposed from the top of the housing 91, and a working plate 93 installed on the support device 911 and covering the locking device 92. To prevent the locking device 92 and the working plate 92 interfering with each other in operation, a compartment 931 is needed to be formed on the bottom of the working plate 93 and corresponds to the locking device 92.

The housing 91 is formed via folding a sheet metal with larger thickness, and the support device 911 is folded or welded from an end of the housing 91. The support device 911 has to receive the locking device 92 and the working plate 93 simultaneously. Therefore, it should increase the area of the support device 911, whereupon, the area of cross-section of the housing 91 is getting larger.

Furthermore, in order to form the compartment 931 on the working plate 93 and maintain the stability of the working plate 93 in operation, it should increase the whole thickness of the working plate 9 as to cause the increase of weight of the saw machine.

Additionally, the conventional working plate is usually made of cast-iron. Cast-iron has bad stability and wear resistance properties and is easy to be influenced via temperature and humidity. It causes higher cost of maintenance.

The present invention is therefore intended to obviate or at least alleviate the problems encountered in prior art.

### SUMMARY OF THE INVENTION

Accordingly, the object is achieved by providing a saw machine that includes a housing, two locking device, a saw means and a granite working plate. The housing further includes a support collar disposed on the top edge thereof and two fixed portions installed onto the inner surface of the front and rear side thereof. The fixed portions are adapted to be below the support collar. Four attached portions are defined on the support collar and adjacent to four corners of the support collar respectively. Each attached portion is formed via folding a stepped portion of the support collar toward the fixed portions and adapted for installing the locking devices thereon. Therefore, the locking devices are disposed in the housing and not exposed from the support collar. Four first connected holes are formed on the support collar, and four threaded holes are defined on the bottom of the granite working plate and respectively correspond to the first connected holes. Therefore, the granite working plate is installed onto the support collar via the first connected holes engaged with the threaded holes. Moreover, the bottom of the granite working plate is spaced from the locking devices.

The primary advantage of the saw machine according to the present invention is to prevent the granite working plate 50 and the locking devices 20 from interfering with one another in operation because the horizontal position of each fixed portion is lower than that of the support collar.

The secondary advantage of the saw machine according to the present invention is material of the working plate being granite.

Other objectives, advantages, and features of the invention will become more apparent from the following detailed description when taken in conjunction with the accompanying drawings.

### BRIEF DESCRIPTION OF THE DRAWINGS

The present invention will be described via detailed illustration of the preferred embodiment referring to the drawings.

FIG. 1 is a cross-sectional view of a conventional saw machine.

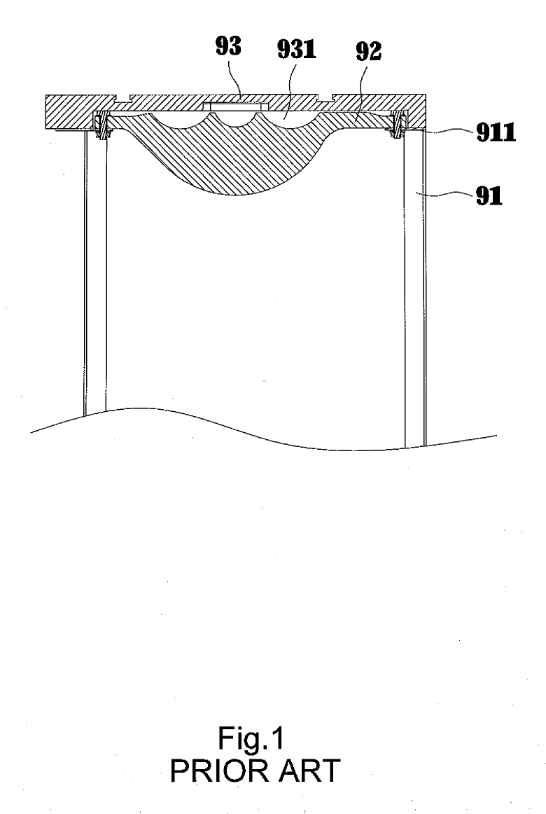

FIG. 2 is a perspective view of a saw machine according to the preferred embodiment of the present invention.

FIG. 3 is an exploded view of the saw machine shown in FIG. 1.

FIG. 4 is a perspective view of a housing of the saw machine shown in FIG. 1.

FIG. 5 is a cross-sectional view taken along 5-5 in FIG. 2.

FIG. 6 is a cross-sectional view taken along 6-6 in FIG. 2.

### DETAILED DESCRIPTION OF THE PREFERRED EMBODIMENT

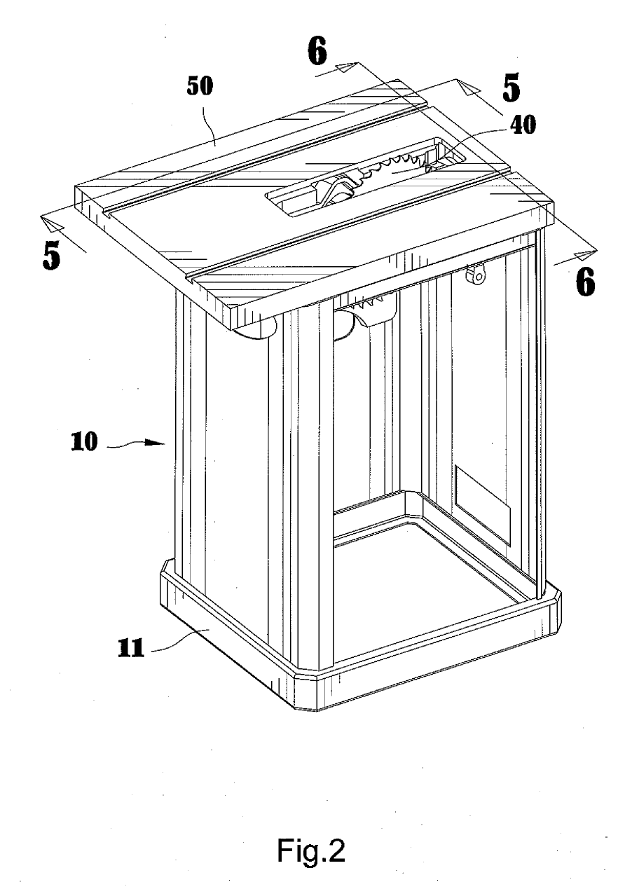

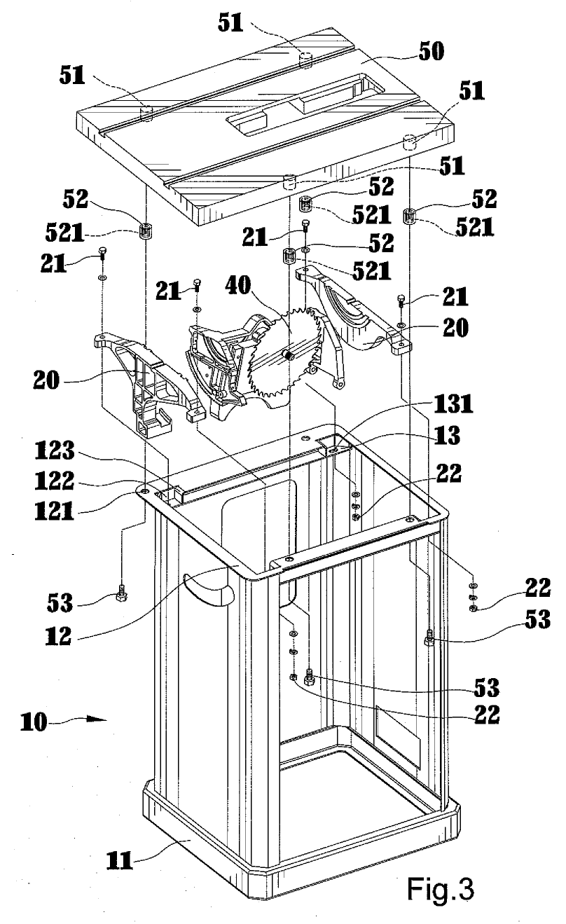

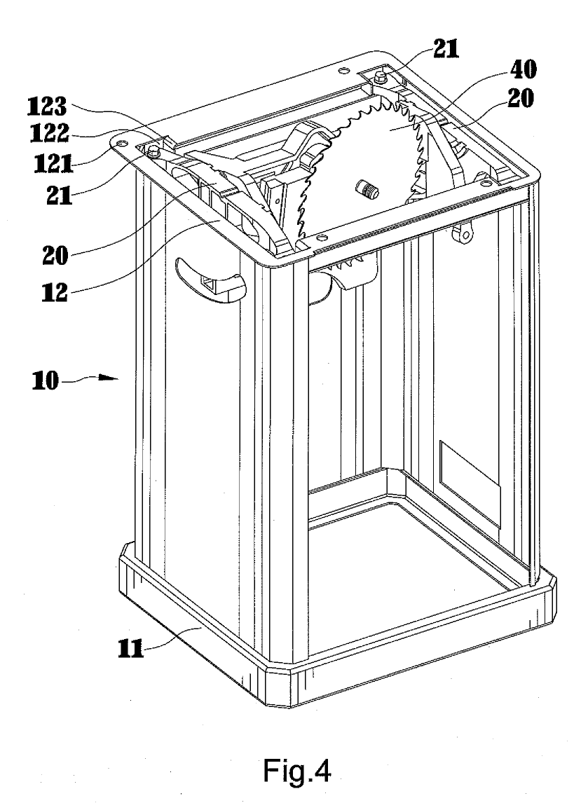

Referring to FIGS. 2 through 4, a saw machine in accordance with the preferred embodiment in the present invention includes a housing 10, two locking devices 20, a saw means 40 and a granite working plate 50.

The housing 10, which is hollow and has an upward opening, includes a base device 11 installed to an end thereof and secured on the ground, and a support collar 12 and two fixed portions 13 formed on the other end thereof opposite to the base device 11. The support collar 12 is provided on the top edge of the housing. Preferably, the support collar 12 is formed via folding outwardly form or welding with the top edge of the housing 10. Additionally, width of each side of the support collar is larger than thickness of the related side of the housing 10. The fixed portions 13 are disposed on the inner surface of the front and rear sides of the housing 10 respectively and below the support collar 12. Preferably, each fixed portion 13 is welded with the inner surface of the housing 10.

Four stepped portions 123 are provided on the support collar 12 and adjacent to four corners of the support collar 12 respectively, with each stepped portion 123 folded toward and fixed on the related fixed portion 13. Four attached portions 122 are delimited by the four stepped portions 123 and the fixed portions 13 respectively, with two of the attached portions 122 adjacent to the front side of the housing 10 and the other two of the attached portions 122 adjacent to the rear side of the housing 10. Four first connected holes 121 are formed on the corners of the support collar 12 adjacent to the attached portions 122 respectively. Four second connected holes 131 are defined on the fixed portions 13 and being adjacent to attached portion 122 respectively, with each second connected hole 131 being a slotted hole. Moreover, each of the stepped portions 123 allows the related second connected hole 131 being exposed and further enhances the structure strength of the fixed portions 13.

The locking devices 20 are disposed between the front and rear sides of the housing 10 below the support collar 12 and spaced from each other. Each locking device 20 is not exposed from the support collar 12. Two ends of each locking device 20 are respectively installed to one of the attached portions 122 adjacent to the front side of the housing 10 and the related attached portion 122 adjacent to the rear side of the housing 10 to be fixed on the fixed portions 13.

Each locking device 20 includes two screw elements 21 and two nut units 22 for engaging with the related second connected holes 131 of the fixed portions 13.

The saw means 40 is conventional and disposed in the interior of the housing 10, with two sides of the saw means 40 installed to the two locking devices 20 respectively.

The granite working plate 50 abuts against the support collar 12 and includes four receiving portions 51 formed on the bottom thereof and respectively corresponding to four first connected holes 121. A block 52 is disposed in each of the receiving portions 51 and has a threaded hole 521 defined therein. A bolt 53 is provided to insert through each first connected hole 121 to engage with each block 52 for fixing the granite working plate 50 onto the support collar 12 of the housing 10. Preferably, the granite working plate 50 is in form of a rectangular figure.

Granite is a common and widely occurring type of intrusive, felsic, igneous rock. Granite has a medium to coarse texture, occasionally with some individual crystals larger than the groundmass forming a rock known as porphyry. Granite is nearly always massive (lacking internal structures), hard and tough, and therefore it has gained widespread use as a construction stone. The average density of granite is 2.75 g/cm³.

Granite is a highly durable siliceous stone. Compared to marble, it is more resistant to the acids found in lemons, vinegars, and cleaning products and usually will not etch. It is an easy stone to live with.

Granite characteristics make this stone virtually scratch proof. It will not scratch even when directly cut on. Things such as keys, coins, utensils, and appliances won't scratch it either.

Granite will actually dull your knives. Little slivers of the knife can become embedded in your stone. This is very noticeable with the darker stones so make a note if you are using your stone as a cutting board.

The characteristics of granite also make this stone heat resistant. It can withstand heat up to 1200 degrees Fahrenheit. You won't have to worry about any burn or char marks. Seams or joints in your stone can weaken it so you probably don't want to put a pot of boiling water near a seam.

Another granite characteristic is the lower water absorption rate when compared to marbles and limestones.

What are the uses of granite? It is most commonly used for countertops and monuments because of its outstanding durability.

Granite is also used for flooring, window sills, shower surrounds, islands, fireplaces, bar tops, and benches. There are fountains, columns, and accessories carved out of granite too.

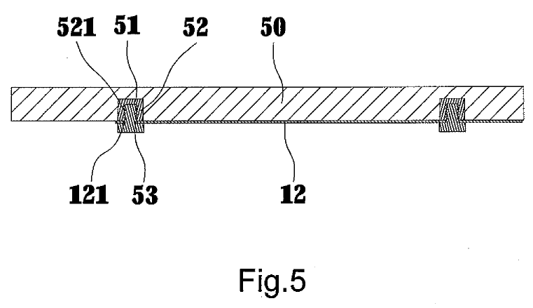

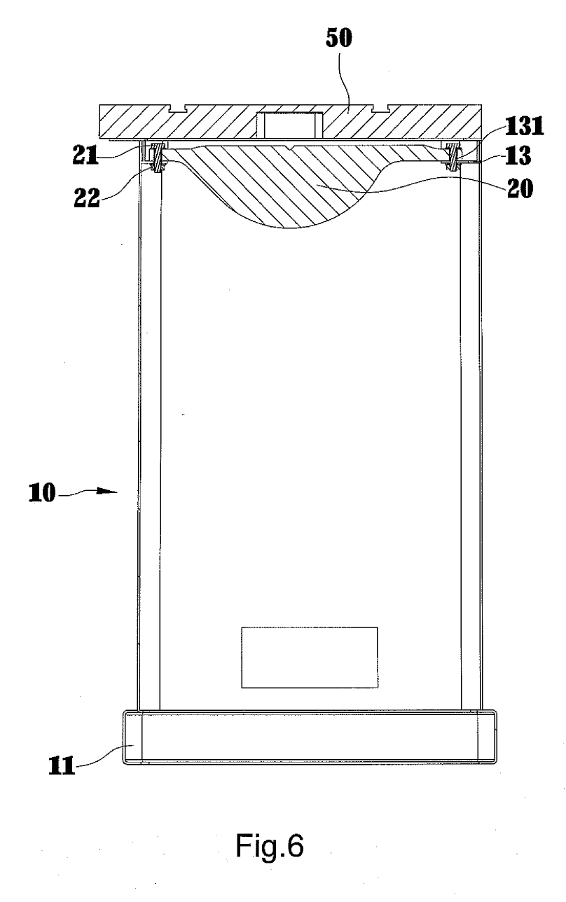

Referring to FIGS. 5 and 6, the granite working plate 50 is disposed on the support collar 12 that extends outwardly from the top edge of the housing 10, and the locking devices 20 are installed on the fixed portions 13 and not exposed from the support collar 12 because the horizontal position of each fixed portion 13 is lower than that of the support collar 12. Therefore, the granite working plate 50 and the locking devices 20 do not interfere with one another in operation.

What is claimed is:

1. A saw machine comprising:
a housing including a support collar disposed on the top edge thereof and two fixed portions respectively disposed in the interior thereof below the support collar;
at least one of attached portions defined between the support collar and the fixed portions;
two locking devices respectively set in the attached portions and fixed to an associated fixed portion, with each locking device disposed below and not exposed from the support collar;
a saw means provided in the housing and installed to the locking devices;
a granite working plate installed onto the top of the support collar and spaced from each locking device.

2. The saw machine as claimed in claim 1, wherein width of each side of the support collar is larger than thickness of the related side of the housing.

3. The saw machine as claimed in claim 1, wherein the support collar is formed via folding the top edge of the housing outwardly.

4. The saw machine as claimed in claim 1, wherein the support collar is welded onto the top edge of the housing.

5. The saw machine as claimed in claim 1, wherein the fixed portions are welded to the inner surface of the housing.

6. The saw machine as claimed in claim 1, wherein comprising four attached portions defined between the support collar and the fixed portions.

7. The saw machine as claimed in claim 6, with the attached portions provided to be adjacent to four corners of the support collar.

8. The saw machine as claimed in claim 1, further comprising at least one stepped portions defined on the support collar and respectively folded toward the fixed portions to form each attached portion of support collar.

9. The saw machine as claimed in claim 6, further comprising four stepped portions defined on the support collar and respectively folded toward the associated fixed portions to form the four attached portions of support collar.

10. The saw machine as claimed in claim 8, with each stepped portion fixed onto an associated fixed portion for enhancing the structure strength of the associated fixed portion.

11. The saw machine as claimed in claim 1, further comprising at least one second connected holes defined on the associated fixed portions and respectively corresponding to the attached portions.

12. The saw machine as claimed in claim 6, further comprising four second connected holes defined on the associated fixed portions and respectively corresponding to the attached portions.

13. The saw machine as claimed in claim 11, further comprising a screw element and a nut unit corresponding to each second connected hole for fixing the locking devices to the fixed portions.

14. The saw machine as claimed in claim 12, farther comprising a screw element and a nut unit corresponding to each second connected hole for fixing the locking devices to the fixed portions.

15. The saw machine as claimed in claim 1, with each second connected hole being in form of a slotted hole.

16. The saw machine as claimed in claim 12, with each second connected hole being in form of a slotted hole.

17. The saw machine as claimed in claim 1, wherein at least one of first connected holes are defined on the support collar and respectively adjacent to the associated attached portions and at least one of threaded holes are defined on the granite working plate and respectively correspond to the first connected holes; wherein the granite working plate further comprising at least one of bolts adapted to engage the first connected holes with the threaded holes respectively.

18. The saw machine as claimed in claim 6, wherein four first connected holes are defined on the support collar and respectively adjacent to the attached portions and four threaded holes are defined on the granite working plate and respectively correspond to the first connected holes; wherein the granite working plate further comprising four bolts adapted to engage the first connected holes with the threaded holes respectively.

19. The saw machine as claimed in claim 17, wherein the granite working plate further comprising at least one of receiving portions formed on the bottom thereof and at least one of blocks adapted disposed in the receiving portions respectively, with the threaded holes defined in the blocks respectively.

20. The saw machine as claimed in claim 18, wherein the granite working plate further comprising four receiving portions formed on the bottom thereof and four blocks adapted disposed in the receiving portions respectively, with the threaded holes defined in the blocks respectively.
